(19) United States
(12) Patent Application Publication
(10) Pub. No.: US 2021/0114930 A1
(43) Pub. Date: Apr. 22, 2021

(54) SILICON MODIFIED VINYL ACETATE ETHYLENE COPOLYMERS

(71) Applicant: DAIREN CHEMICAL CORPORATION, Taipei (TW)

(72) Inventor: Feng-Chuan CHANG, Taipei (TW)

(21) Appl. No.: 17/136,687

(22) Filed: Dec. 29, 2020

Related U.S. Application Data
(62) Division of application No. 16/385,842, filed on May 2, 2019.

(51) Int. Cl. C04B 24/26; C08F 216/38; C04B 40/00; C04B 28/02

(52) U.S. Cl. CPC C04B 24/2688; C08F 216/38; C04B 2111/27; C04B 28/02; C04B 40/0039

(57) ABSTRACT

This disclosure relates to silicon modified vinyl acetate ethylene copolymers and to emulsions and articles of manufacture based on the same.

### FIELD OF THE INVENTION

This invention relates to silicon modified vinyl acetate ethylene copolymers and to emulsions and articles of manufacture based on the same.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Vinyl acetate ethylene (VAE) copolymers and emulsions thereof are used in various applications for example as binders for adhesives, paints, and as coating materials. However, the overall performance of known vinyl acetate ethylene copolymers and emulsions based on known vinyl acetate ethylene copolymers is not always satisfactory.

Thus there is a need in the art for vinyl acetate ethylene copolymers and emulsions based thereon that have improved characteristics and properties. The silicon modified vinyl acetate ethylene copolymers of the present invention meet that need.

### SUMMARY OF THE INVENTION

The following embodiments and aspects thereof are described and illustrated in conjunction with systems, compositions, methods, and articles of manufacture which are meant to be exemplary and illustrative, not limiting in scope.

In various embodiments, the present invention provides a silicon modified vinyl acetate ethylene copolymer, comprising: 60 to 95 percent by weight (wt. %) of vinyl acetate units; 0.1 to 35 wt. % of ethylene units; and 0.1 to 5 wt. % of a unit originated from a silicon compound of Formula (I);

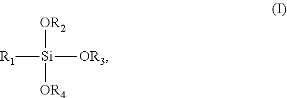

where, R₁ is a terminally unsaturated alkenyl radical; and R₂, R₃, and R₄ are each independently selected from the group consisting of H, alkyl, substituted alkyl, heteroalkyl, substituted heteroalkyl, cyclyl, substituted cyclyl, heterocyclyl, substituted heterocyclyl, aryl, substituted aryl, heteroaryl, and substituted heteroaryl, and wherein a content of silicon by toluene extraction bonded to the silicon modified vinyl acetate ethylene copolymer is from 0.01 to 0.3 wt. %.

In some embodiments, the silicon modified vinyl acetate ethylene copolymer has a content of toluene-insoluble matter in the ranged of 13 to 80 wt. %.

In some embodiments, the silicon compound of Formula (I) is selected from the group consisting of vinyltrimethoxysilane (VTMO), vinyltriethoxysilane (VTEO), γ-methacryloxypropyltrimethoxysilane (MEMO), and vinyltris(2-methoxyethoxy)silane (VTMOEO). Non-limiting examples of the silicon compound of Formula (I) include vinyltrimethoxysilane (VTMO), vinyltri ethoxysilane (VTEO), vinyl diethoxysilanol, vinylethoxysilane diol, vinyldi(methoxy-methoxy)-silanol, allyltriethoxysilane, vinyltripropoxysilane, vinyltriisopropoxysilane, vinyltributoxysilane, vinyltri acetoxysilane, vinyltri(methoxy-methoxy)-silane, (vinyltrimethylglycolsilane), γ-methacryloxypropyltri(methoxy-methoxy)-silane, γ-methacryloxypropyltrimethylglycol-silane, γ-methacryloxypropyltrimethoxysilane (MEMO), γ-acryloxypropyltriethoxysilane, and vinyltris(2-methoxyethoxy)silane (VTMOEO). In some embodiments, the silicon compound of Formula (I) is selected from the group consisting of vinyltrimethoxysilane (VTMO), vinyltriethoxysilane (VTEO), vinyldiethoxysilanol, vinylethoxysilane diol, vinyldi(methoxy-methoxy)-silanol, allyltriethoxysilane, vinyltripropoxysilane, vinyltriisopropoxysilane, vinyltributoxysilane, vinyltriacetoxysilane, vinyltri(methoxy-methoxy)-silane, (vinyltrimethylglycol silane), γ-methacryloxypropyltri(methoxy-methoxy)-silane, γ-methacryloxypropyltrimethylglycol-silane, γ-methacryloxypropyltrimethoxysilane (MEMO), γ-acryloxypropyltriethoxysilane, and vinyltris(2-methoxyethoxy)silane (VTMOEO).

In some embodiments, the silicon modified vinyl acetate ethylene copolymer has a number average molecular weight (Mn) of 24,000 to 50,000 g/mol. In some embodiments, the silicon modified vinyl acetate ethylene copolymer has a number average molecular weight (Mn) of 24,000 to 40,000 g/mol. In some embodiments, the silicon modified vinyl acetate ethylene copolymer has a number average molecular weight (Mn) of 25,000 to 35,000 g/mol.

In some embodiments, the silicon modified vinyl acetate ethylene copolymer has a polydispersity index of 1.50 to 2.50. In some embodiments, silicon modified vinyl acetate ethylene copolymer has a polydispersity index of 2.00 to 2.50.

In some embodiments, the toluene-insoluble matter has an ethylene to vinyl acetate ratio of 0.2:1 to 0.8:1. In some embodiments, the toluene-insoluble matter has an ethylene to vinyl acetate ratio of 0.25:1 to 0.4:1.

In some embodiments, the content of silicon is measured by scanning electron microscope energy dispersive spectroscopy.

In some embodiments, the silicon modified vinyl acetate ethylene copolymer has a water solubility of 0 to 3 wt. % at about 25° C. In some embodiments, the silicon modified vinyl acetate ethylene copolymer has a water solubility of 0.9 to 2.0 wt. % at about 25° C.

In some embodiments, the silicon modified vinyl acetate ethylene copolymer has a tensile strength at break of 18 to 24 kg/mm². In some embodiments, the silicon modified vinyl acetate ethylene copolymer has an elongation at break of 600 to 850%. In some embodiments, the silicon modified vinyl acetate ethylene copolymer has a Tg (onset) of 2.0 to 4.0° C.

In various embodiments, the present invention provides an article of manufacture, comprising the above-described silicon modified vinyl acetate ethylene copolymer.

In some embodiments, the article of manufacture is selected from the group consisting of an adhesive, tile adhesive, thermal insulated adhesive, waterproof coating, cement whitening agent, filler compound, wall fill compound, sealing paste, scrub resistance agent, paper coating, paint, and textile.

In various embodiments, the present invention provides an emulsion comprising the above-described silicon modified vinyl acetate ethylene copolymer; and an aqueous component.

In various embodiments, the present invention provides a cementitious waterproofing composition, comprising: (a) a liquid part, wherein the liquid part comprises the above-described silicon modified vinyl acetate ethylene copolymer; and an aqueous component; and (b) a solid part, wherein the solid part comprises at least one inorganic cement.

It has been surprisingly found by the present inventors that, by adjusting the polymerization process including the order of addition of the silicon compound, polymerization temperature, impeller type and agitating speed, and combining the specific surfactant and silicon compound, the obtained silicon modified vinyl acetate ethylene copolymer provides better water resistance compared to traditional vinyl acetate-ethylene copolymer. In addition, the emulsion, articles of manufacture and cementitious water proofing composition based on the same also exhibit excellent water resistance.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1A-1B depicts in accordance with various embodiments of the present invention Gel Permeation Chromatography (GPC) chromatograms of silicon modified vinyl acetate ethylene copolymers. FIG. 1A is a GPC chromatogram of a silicon modified vinyl acetate ethylene copolymer of Example 1F (Table 1) having a number average molecular weight (Mn) of 24,060 g/mol and a polydispersity index (PDI) of 2.16. FIG. 1B is a GPC chromatogram of a silicon modified vinyl acetate ethylene copolymer of Example 1B (Table 1) having a number average molecular weight (Mn) of 40,698 g/mol and a polydispersity index (PDI) of 1.59.

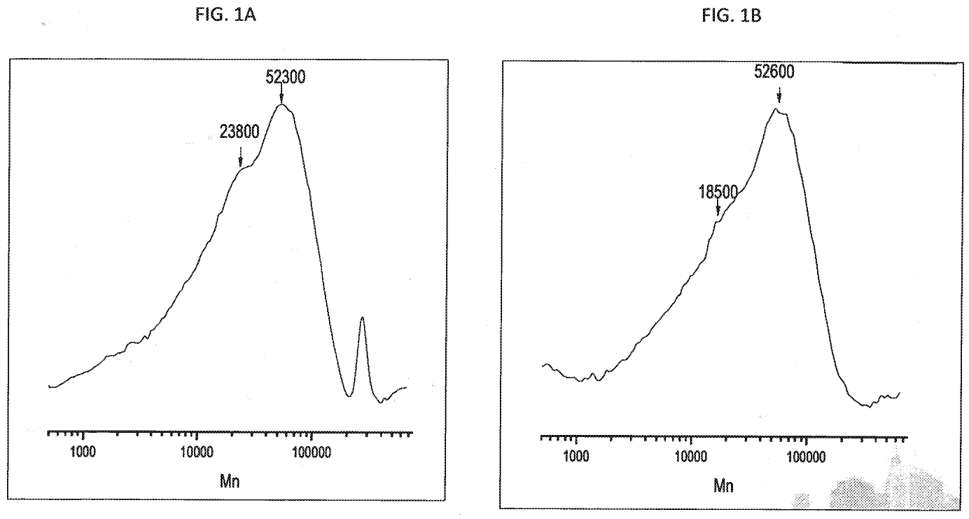

FIG. 2 depicts in accordance with various embodiments of the present invention a graph showing the water solubility (wt. %) of copolymers corresponding to the Comparative Example 1A and Examples 1B-1G.

FIG. 3 depicts in accordance with various embodiments of the present invention a graph showing the content of toluene-insoluble matter (wt. %) of copolymers corresponding to the Comparative Example 1A and Examples 1B-1G.

FIG. 4 depicts in accordance with various embodiments of the present invention a graph showing the elongation (%) of copolymers corresponding to the Comparative Example 1A and Examples 1B-1G.

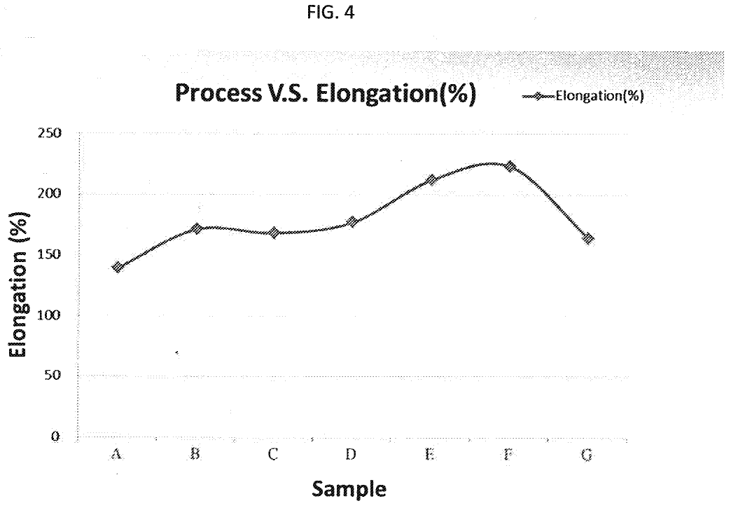

FIG. 5 is a tabular listing of the results of Comparative Examples 1 and 1A versus Examples 1B, 1C, 1D, 1E, 1F, 1G, 1H, 1I, 1J, 1K, 1L and 1M, arranged as Table 1.

### DETAILED DESCRIPTION OF THE INVENTION

All references cited herein are incorporated by reference in their entirety as though fully set forth. Unless otherwise defined, all technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. Unless otherwise defined, all technical and scientific terms used herein have the same meaning as commonly understood by one of ordinary skill in the art to which this invention belongs. It should be understood that this invention is not limited to the particular methodology, protocols, and reagents, etc., described herein and as such can vary. The definitions and terminology used herein are provided to aid in describing particular embodiments, and are not intended to limit the claimed invention, because the scope of the invention is limited only by the claims.

Groupings of alternative elements or embodiments of the present invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Substituents may be protected as necessary and any of the protecting groups commonly used in the art may be employed. Non-limiting examples of protecting groups may be found, for example, in Greene and Wuts, Protective Groups in Organic Synthesis, 44^{th}. Ed., Wiley & Sons, 2006.

In some embodiments, a straight chain or branched chain alkyl has 30 or fewer carbon atoms in its backbone (e.g., C₁-C₃₀ for straight chains, C₃-C₃₀ for branched chains), and in some embodiments 20 or fewer. Likewise, in some embodiments cycloalkyls have from 3-10 carbon atoms in their ring structure, and some embodiments have 5, 6 or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone. Unless the number of carbons is otherwise specified, “lower alkyl” as used herein means an alkyl group, as defined above, but having from one to ten carbon atoms in its backbone structure. In other embodiments, a sub group of the “lower alkyl” may have from one to six carbon atoms in its backbone structure.

Synthetic Preparation. In various embodiments, compounds, compositions, formulations, articles of manufacture, reagents, products, etc. (e.g., compositions, polymers, copolymers, emulsions, cementitious waterproofing compositions, etc.) of the present invention as disclosed herein may be synthesized using any synthetic method available to one of skill in the art. In various embodiments, the compounds, compositions, formulations, articles of manufacture, reagents, products, etc. (e.g., compositions, polymers, copolymers, emulsions, cementitious waterproofing compositions, etc.) of the present invention disclosed herein can be prepared in a variety of ways known to one skilled in the art of organic synthesis, and in analogy with the exemplary compounds, compositions, formulations, articles of manufacture, reagents, products, etc. whose synthesis is described herein. The starting materials used in preparing these compounds, compositions, formulations, articles of manufacture, reagents, products, etc. may be commercially available or prepared by known methods. Preparation of compounds, can involve the protection and deprotection of various chemical groups. The need for protection and deprotection, and the selection of appropriate protecting groups can be readily determined by one skilled in the art. The chemistry of protecting groups can be found, for example, in Greene and Wuts, Protective Groups in Organic Synthesis, 44th. Ed., Wiley & Sons, 2006, which is incorporated herein by reference in its entirety. Non-limiting examples of synthetic methods used to prepare various embodiments of compounds, compositions, formulations, articles of manufacture, reagents, products, etc. (e.g., compositions, polymers, copolymers, emulsions, cementitious waterproofing compositions, etc.) of the invention are disclosed in the Examples section herein. The reactions of the processes described herein can be carried out in suitable solvents which can be readily selected by one of skill in the art of organic synthesis. Suitable solvents can be substantially nonreactive with the starting materials (reactants), the intermediates, or products at the temperatures at which the reactions are carried out, i.e., temperatures which can range from the solvent's freezing temperature to the solvent's boiling temperature. A given reaction can be carried out in one solvent or a mixture of more than one solvent. Depending on the particular reaction step, suitable solvents for a particular reaction step can be selected.

Silicon Modified Vinyl Acetate Ethylene Copolymer

In forming the silicon modified vinyl acetate ethylene copolymers disclosed herein, those skilled in the art know that they may be formed of monomers, oligomers, or even other pre-cursors of the copolymer, sometimes termed monomer residue, as components of the precursors are lost during the reaction, such as the loss of water molecules in a condensation reaction. Thus, it should be understood throughout this specification and claims that the skilled worker in the art to whom this disclosure is directed will understand that when we speak of a copolymer comprising different units or sub-units, such as vinyl acetate, ethylene, silicon compound (e.g., silicon compound of Formula (I)), the units or sub-units to which we are referring are the monomer, oligomer, or polymer pre-cursors of such units and/or sub-units.

In various embodiments, the present invention provides a silicon modified vinyl acetate ethylene copolymer, comprising: (i) 60 to 95 wt. % of vinyl acetate units; (ii) 0.1 to 35 wt. % of ethylene units; and (iii) 0.1 to 5 wt. % of a unit originated from a silicon compound of Formula (I):

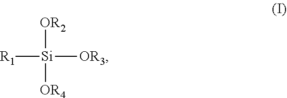

where, R₁ is a terminally unsaturated alkenyl radical; and R₂, R₃, and R₄ are each independently selected from the group consisting of H, alkyl, substituted alkyl, heteroalkyl, substituted heteroalkyl, cyclyl, substituted cyclyl, heterocyclyl, substituted heterocyclyl, aryl, substituted aryl, heteroaryl, and substituted heteroaryl, and wherein a content of silicon bonded to the silicon modified vinyl acetate ethylene copolymer is from 0.01 to 0.3 wt. %.

In some embodiments, the content of silicon bonded to the silicon modified vinyl acetate ethylene copolymer is measured by scanning electron microscope energy dispersive spectroscopy (SEM/EDS).

In preferred embodiments, the silicon-bonded content of the silicon modified vinyl acetate ethylene copolymer is measured by SEM/EDS, after volatilizing the solvent.

Number Average Molecular Weight (Mn)

In some embodiments, the silicon modified vinyl acetate ethylene copolymer has a number average molecular weight (Mn) of 24,000 to 50,000 g/mol. In some embodiments, the silicon modified vinyl acetate ethylene copolymer has a number average molecular weight (Mn) of 24,000 to 40,000 g/mol. In some embodiments, the silicon modified vinyl acetate ethylene copolymer has a number average molecular weight (Mn) of 25,000 to 35,000 g/mol which is a best mode.

Polydispersity Index (PDI)

In some embodiments, the silicon modified vinyl acetate ethylene copolymer has a polydispersity index of 1.50 to 2.50. In some embodiments, the silicon modified vinyl acetate ethylene copolymer has a polydispersity index of 2.0 to 2.50.

Toluene Insoluble Matter

The term “toluene-insoluble matter” means that the insoluble, cross-linked part of the above-described silicon modified vinyl acetate ethylene (VAE) copolymer. And the insoluble, cross-linked part is extracted from the sample of dried silicon modified VAE copolymer film with toluene. According to the specific range of the toluene-insoluble matter, the modified vinyl acetate ethylene copolymer exhibits excellent water resistance

In some embodiments, the toluene-insoluble matter has an ethylene to vinyl acetate ratio (ethylene:vinyl acetate ratio) of 0.2:1 to 0.8:1. In some embodiments, the toluene-insoluble matter has an ethylene to vinyl acetate ratio (ethylene:vinyl acetate ratio) of 0.25:1 to 0.4:1.

In some embodiments, the silicon modified vinyl acetate ethylene copolymer has a water solubility of 0 to 3 wt. % at about 25° C. In some embodiments, the silicon modified vinyl acetate ethylene copolymer has a water solubility of 0.9 to 2.0 wt. % at about 25° C.

In some embodiments, the silicon modified vinyl acetate ethylene copolymer has a tensile strength at break of 18 to 24 kg/mm².

In some embodiments, the silicon modified vinyl acetate ethylene copolymer has an elongation at break of 600 to 850%. In some embodiments, the silicon modified vinyl acetate ethylene copolymer has an elongation above 700%.

In some embodiments, the silicon modified vinyl acetate ethylene copolymer has a Tg (onset) of 2.0 to 4.0° C.

Articles of Manufacture

In various embodiments, the present invention provides an article of manufacture comprising the above-described silicon modified vinyl acetate ethylene copolymer.

In some embodiments, the article of manufacture is selected from the group consisting of an adhesive, tile adhesive, thermal insulated adhesive, waterproof coating, cement whitening agent, filler compound, wall fill compound, sealing paste, scrub resistance agent, paper coating, paint, and textile and cementitious waterproofing composition.

Emulsion

In various embodiments, the present invention provides an emulsion comprising the above-described silicon modified vinyl acetate ethylene copolymer; and an aqueous component.

Aqueous Component

The aqueous component may be any suitable aqueous phase suitable for the intended use. In various embodiments, the aqueous component comprises water, fresh water, salt water, sea water, purified water, reclaimed water, recycled water, deionized water, distilled water, tap water, plant water, and a combination thereof. In some embodiments, the aqueous component may comprise other constituents and/or additives.

In some embodiments of the emulsion, the silicon modified vinyl acetate ethylene copolymer may be added in an amount of about 0.05% to 2.36% based on the total weight of the emulsion.

In some embodiments of the emulsion, the aqueous component may be added in an amount of about 25% to 70%, preferably 40% to 50%, based on the total weight of the emulsion.

In some embodiments, the emulsion further comprises at least one additive.

In some embodiments, the at least one additive may be added in an amount of about 0.01% to 3% based on the total weight of the emulsion.

Emulsion Polymerization

In various embodiments of the present invention the silicon modified vinyl acetate ethylene copolymer may be prepared by emulsion polymerization of vinyl acetate, ethylene, and a silicon compound of Formula (I).

Emulsion polymerization is well known in the art. In various embodiments of the present invention, the emulsion polymerization may be performed by the following steps: feeding an aqueous component to a reactor under stirring; evacuating the reactor under vacuum and purging with nitrogen; heating the reactor; adding to the reactor a vinyl acetate monomer, a silicon compound of Formula (I), and ethylene; and adding an initiator to the reactor to perform the emulsion polymerization.

Preference is given to the emulsion polymerization process. The polymerization temperature generally being from about 40° C. to about 100° C. Preferably, the polymerization temperature ranges from about 60° C. to about 90° C. The agitating speed of polymerization ranges from 250 to 400 rpm. As to the impeller type used for polymerization, it can be selected from group consisting of anchor, paddle, and marine propeller. When gaseous co-monomers are to be copolymerized, e.g., ethylene, 1,3-butadiene or vinyl chloride, the polymerization can also be carried out at superatmospheric pressure, e.g., pressure from about 5 to about 100 bar.

Generally, the polymerization is initiated using the water-soluble or monomer-soluble initiators commonly used for emulsion or suspension polymerization, or redox-initiator combinations. Examples of water-soluble initiators are the sodium, potassium, and ammonium salts of peroxydisulfuric acid, hydrogen peroxide, tert-butyl peroxide, tert-butyl hydroperoxide, potassium peroxydiphosphate, tert-butyl peroxypivalate, cumene hydroperoxide, isopropylbenzene monohydroperoxide, and azobisisobutyronitrile. Examples of monomer-soluble initiators are dicetyl peroxydicarbonate, dicyclohexyl peroxydicarbonate, and dibenzoyl peroxide. The amount of the initiators generally used, based on the total weight of the monomers, is from about 0.001 to about 0.5% by weight. In some embodiments, the amount of the initiators used, based on the total weight of the monomers, is from about 0.001 to about 0.02% by weight, preferably from about 0.001 to about 0.1% by weight. In some embodiments, the amount of the initiators used, based on the total weight of the monomers, is from about 0.01 to about 0.5% by weight.

The initiators, especially redox initiators, can be used with reducing agents. Exemplary reducing agents include, but are not limited to, the sulfites and bisulfites of the alkali metals and of ammonium, e.g., sodium sulfite, the derivatives of sulfoxylic acid, e.g., the formaldehydesulfoxylate of zinc or of an alkali metal, e.g., sodium hydroxymethanesulfinate, and ascorbic acid. The amount of reducing agent used, based on the total weight of the monomers, can range from about 0.001 to about 0.5% by weight.

In some embodiments, the amount of the reducing agent used, based on the total weight of the monomers, is from about 0.001 to about 0.03% by weight, preferably from about 0.001 to about 0.015% by weight. In one embodiment, the amount of reducing agent used, based on the total weight of the monomers, is from about 0.01 to about 0.5% by weight, based on the total weight of the monomers.

Without wishing to be bound by a theory, the molecular weight of the copolymer can be controlled during the polymerization process by use of chain transfer agents. When used, the chain transfer agents can be used in an amount ranging from about 0.01 to 5.0% by weight, based on the monomers to polymerized. Without limitations, the chain transfer agents can be used either as a separate feed or pre-mixed with reaction components. Exemplary chain transfer agents include, but are not limited to, n-dodecyl mercaptan, tert-dodecyl mercaptan, mercaptopropionic acid, methyl mercaptopropionate, isopropanol, and acetaldehyde.

In some embodiments, no chain transfer agents are used.

Regardless of the polymerization process employed, all of the monomers can be present in the initial charge, all can be supplied as a feed, or some of the monomers can be present in the initial charge, the remainder fed in after initiation of the polymerization.

In some embodiments, the procedure is preferably that from 50 to 100% by weight of the monomers, based on their total weight, form the initial charge, the remainder supplied as a feed. The feeds can be separate (in space and time) or some or all of the components can be fed in pre-emulsified form.

In preferred embodiments, the procedure termed “terminal addition” is that from 50 to 100% by weight of the monomers, based on their total weight, form the initial charge but not included the above-described silicon compound of Formula (I); the remainder including the above-described silicon compound of Formula (I) supplied as a feed.

In some embodiments, the emulsion polymerization is performed in the presence of at least one additive. In some embodiments the at least one additive is selected from the group consisting of a surfactant; protective colloid; and a combination thereof. Further, the polymerization can be in the presence of protective colloids and/or of emulsifiers.

Exemplary protective colloids include, but are not limited to, partially hydrolyzed polyvinyl alcohols; polyvinylpyrrolidones; polyvinyl acetals; polysaccharides in water-soluble form, e.g., starches (amylose and amylopectin), cellulose ether as polymeric protective colloid for the present invention include, but not limited to celluloses and their carboxymethyl, methyl, hydroxyethyl, hydroxypropyl derivatives; proteins, such as caseine or caseinate, soya protein, gelatin; ligninsulfonates; synthetic polymers, such as poly(meth)acrylic acid, copolymers of (meth)acrylates having carboxy-functional comonomer units, poly(meth)acrylamide, polyvinylsulfonic acids and their water-soluble copolymers; melamine-formaldehydesulfonates, naphthalene-formaldehydesulfonates, styrene-maleic acid copolymers, vinyl ether-maleic acid copolymers.

Preferred protective colloids include partially hydrolyzed or completely hydrolyzed polyvinyl alcohols having a degree of hydrolysis of from 80 to 100 mol. %. In some embodiments, the protective colloids include partially hydrolyzed polyvinyl alcohols having a degree of hydrolysis of 88 mol. % and viscosity of 5 cps.

Generally, the total amount of the protective colloids used, based on the total weight of the monomers, in the polymerization is from 1 to 20% by weight. In some preferred embodiments, the total amount of the protective colloids used, based on the total weight of the monomers, in the polymerization is from 1.0 to 7.5% by weight. It is possible for all of the protective colloid content to form an initial charge, or else to be divided between initial charge and feed.

As noted above, the polymerization can be carried out in the presence or absence of emulsifiers. Suitable emulsifiers are either anionic, cationic, or else non-ionic emulsifiers, e.g. anionic surfactants, such as alkyl sulfates having a chain length of from 8 to 18 carbon atoms, alkyl or alkylaryl ether sulfates having from 8 to 18 carbon atoms in the hydrophobic radical and up to 40 ethylene oxide or propylene oxide units, alkyl- or alkylarylsulfonates having from 8 to 18 carbon atoms, esters and half-esters of sulfosuccinic acid with monohydric alcohols or with alkylphenols, and nonionic surfactants, such as alkyl polyglycol ethers or alkylaryl polyglycol ethers having from 8 to 40 ethylene oxide units. Suitable nonionic surfactant includes, for example, from C₆ to C₁₂ alkylphenol ethoxylates, ethylene oxide/propylene oxide (EO/PO) block copolymers of formula (II), wherein X+Z ranges from 10% to 80%, y ranges from 3 mole to 10 mole. When used, the emulsifier can be used in an amount ranging from about 0.1 to about 5% by weight, based on the amount of monomers.

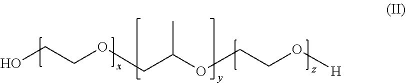

Once the polymerization has been concluded, post-polymerization can be carried out using known methods to remove residual monomers, for example using redox-catalyst-initiated post-polymerization. Volatile residual monomers can also be removed by means of distillation. Such distillation can be at subatmospheric pressure, optionally with passage of inert entrainer gases, such as air, nitrogen, or steam, through or over the product. The aqueous polymer dispersions can have a solids content from about 30 to about 75% by weight, preferably from 50 to 60% by weight.

In various embodiments of the present invention, an emulsion comprising a silicon modified vinyl acetate ethylene copolymer may be used to prepare a cementitious waterproofing composition.

Cementitious Waterproofing Composition

In various embodiments, the present invention provides a cementitious waterproofing composition, comprising: (a) a liquid part, wherein the liquid part comprises the above-described silicon modified vinyl acetate ethylene copolymer; and an aqueous component; and (b) a solid part, wherein the solid part comprises at least one cement.

In some embodiments of the cementitious waterproofing composition, the cement may be added in an amount of about 25 wt. % to 75 wt. %, preferably about 30 wt. % to 60 wt. %, based on the total weight of the polymer cement waterproof composition.

In some embodiments, the solid part comprises at least one selected from group consisting of at least one cement, at least one filler, and at least one additive. In some embodiments, the solid part comprises at least one cement.

In some embodiments, the liquid part and the solid part combine to form the cementitious waterproofing composition. In some embodiments, the liquid part and the solid part are combined together to form the cementitious waterproofing composition. In some embodiments, the solid part and liquid part form the cementitious waterproofing composition upon mixing.

Non-limiting examples of cement suitable for use in the present invention include portland cement, aluminate cement, sulphoaluminate cement, ferroaluminate cement, ferroaluminate cement, fluoaluminate cement, cement comprising volcanic ash, and any combination thereof. In some embodiments, the cement is selected from the group consisting of portland cement, aluminate cement, sulphoaluminate cement, ferroaluminate cement, ferroaluminate cement, fluoaluminate cement, cement comprising volcanic ash, and a combination thereof.

In some embodiments of the cementitious waterproofing composition, the liquid part may be added in an amount of about 15% to 40% based on the total weight of the polymer cement waterproof composition.

In some embodiments of the cementitious waterproofing composition, the solid part may be added in an amount of about 60% to 85% based on the total weight of the polymer cement waterproof composition.

In various embodiments, the liquid part comprises about 30% to 70% by weight of a silicon modified vinyl acetate ethylene copolymer. In various embodiments, the liquid part further comprises at least one additive. Non-limiting examples of additives for use in the liquid part include wetting agents, preservatives, defoamers, and any combination thereof.

In some embodiments, the cementitious waterproofing composition has a tensile strength of 17.0 to 26.0 kg/mm².

In some embodiments, the cementitious waterproofing composition has an elongation of 171 to 239%.

In some embodiments, the cementitious waterproofing composition has a tensile strength of 17.0 to 26.0 kg/mm², and an elongation of 171 to 239%.

In various embodiments of the present invention the cementitious waterproofing composition may be prepared by the following steps: forming a liquid part by mixing a silicon modified vinyl acetate ethylene copolymer (or emulsion thereof), an aqueous component, and optionally at least one additive; forming a solid part by mixing at least one cement, and optionally at least one additive; and mixing the liquid part and the solid part in a ratio to obtain a cementitious waterproofing composition.

It should be understood that this invention is not limited to the particular methodologies, protocols, and reagents, etc., described herein and as such can vary therefrom. The terminology used herein is for the purpose of describing particular embodiments only, and is not intended to limit the scope of the present invention, which is defined solely by the claims.

### EXAMPLES

The invention is further illustrated by the following examples which are intended to be purely exemplary of the invention, and which should not be construed as limiting the invention in any way. The following examples are illustrative only, and are not intended to limit, in any manner, any of the aspects described herein. The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

Method of Measurement:

Solids Content
This is a method for measuring the solids contents of an aqueous emulsion by thermal evaporation of volatiles. The measurement if performed on Moisture Balance. It uses infrared radiation to accomplish drying.
   Press (Mettler GA45) “Def ID” key on the printer to input the sample name, then press the “Enter” key.
   Put the aluminum pan (ID 100 mm, Thickness 0.5˜1.0 mm) on the moisture balance (Mettler PM100 balance & LP-16 Set point: temperature 150° C., Weight Threshold/30 sec.), then press the “Zero” bar to zero the weight.
   Rapidly spread about 1.2 g of the EVA emulsion sample with spoon over the aluminum pan on the moisture balance.
   Immediately press the “Start” key on LP-16 to start the heater: The printer will print out the initial weight.
   The test will automatically stop when the weight change is less than 0.01% within 30 seconds the printer will print out both, the final weight as well as the solid content of the emulsion.

Free Monomer (or “FM”)
This procedure provides a method for determining the amount of unreacted vinyl acetate in a latex emulsion by bromination of the double bonds between carbon and oxygen.
   Weigh about 2˜3 grams of EVA emulsion sample in the beaker.
   Dilute the emulsion with about 50 ml of deionized water and start the auto-titrator (Mettler DL-40GP).
   Read the result of titration.
Calculation:

$$Free monomer ( wt \% ) = \frac{A \times F \times 0.43}{S}$$

A: ml of Bromine solution being titrated
F: Factor of 0.1N Bromine solution
S: Sample Weight (g)
Record the result to the nearest 0.01%.

Tg

This procedure provides a method for determining the glass transition (Tg) temperatures of emulsions of emulsion polymers by differential scanning calorimetry (DSC PE DSC7). For an amorphous polymer, the glass transition temperature (Tg) is the region at which a physical change from a glassy, brittle state to a rubbery, liquid-like state occurs. Tg is a measure of the onset of molecular motion induced by thermal energy. For DSC, the X-axis of the output represents temperature (° C.) and the Y-axis is related to the heat capacity of the polymer (mW). A glass transition is observed as a change in the baseline. An onset Tg is measured as the temperature at the intersection of the extrapolated baseline and the vertical portion of the transition.

Pretreatment
(1) Weigh about 34 mg of EVA emulsion into sample pan (Specified for DSC 0.5 cm (O.D.).
(2) Dry the sample in the vacuum oven at 80° C. for 1.5 hr.
(3) Take the sample out from vacuum oven and cool it in the desiccator for 30 minutes.
(4) Cover the sample tightly with sample pan crimper.
(5) Calibration should be performed daily before analysis.

The standard for calibration is pure ACS grade cyclohexane (melting point 6.54° C.), the deviation should be less than 0.2° C.

### Procedure of Analysis

(1) Put the crimped pan in the sample holder of DSC (Differential Scanning calorimeter) (PE DSC7).
(2) Balance the sample holder by placing an empty vial opposite the sample.
(3) The program of temperature is increasing the temperature 20° C./min from −50° C. up to +40°
(4) Start the program. Measure the glass transition temperature. The differential temperature curve between pan with and without film sample is evaluated by the computer.

Stability
This work instruction describes the procedure to determine the dilution stability of VAE in process and VAE emulsion.
   Weigh accurately 5 g of emulsion in a beaker.
   Add 85 g of pure water into the beaker and thoroughly mix the emulsion.
   Transfer the sample into a Nessler tube (30 cm height×1.7 cm diameter) until the 50 ml mark and allow the sample to sit for 72 hours.
   Measure the total length of sample, upper clear portion and sediment portion.
Result
   Upper clear portion (%)=[Length of upper clear portion/Total length of sample]×100
   Sediment portion (%)=[Length of sediment portion/Total length of sample]×100

Elongation and Tensile Strength.
Spread 15 grams EVA emulsion sample on the stainless steel plate and dry it for at least 2 days. Carefully peel the film off from the plate. Cut out the test pieces with standard template. Evaluate the 4 film average thickness
(t) of the film within the middle (narrower) part of it with micrometer.
Perform the test as follows:
Fix sample in the Material testing machine (Instron machine 1011 with 50 Kg weight beam);
   Distance from bracket to bracket=2.5 cm;
   Start machine and stop it exact at break of the film.
   Then note both, the total distance (L) between the brackets now and the tear strength (force F).
Calculation:
   Tensile strength (Kg/cm2)=F/(W*t)
      F: Force at break (tear strength at break of film)
      W: Width of narrow middle part of the film (0.5 cm)
      t: Average thickness of film
   Elongation ratio (%)=(L−2.5)/(2.5)×100
      L: Total extension length

Toluene-insoluble matter
1. Prepare a dry film of the emulsion on the glass plate, tear it off cut out a piece of about 0.5 g (Ws).
2. Dry the stainless sieve in the oven at 105±5° C. for 2 hours.
3. Cool sieve in desiccator for 30 minutes, then weigh it.
4. Put this dry piece of film into a 250 ml Erlenmeyer flask and add 100 ml of toluene.
5. After fixing the condenser, heat the sample in the water bath at 70±3° C. for 3 hours, then filter the contents of the flask through the stainless sieve.
6. Heat the sieve in the oven at 105±5° C. for 3 hours, in order to evaporate residual solvent.
7. Cool the sieve down to room temperature in the desiccator. 8. Weigh the filter sieve.

Toluene-insoluble matter (%)=[(W1−W0)/Ws]×100 Calculation
W0: Weight of stainless sieve.
W1: Weight of the stainless sieve with residual polymer film
Ws: Weight of untreated original sample of film

Waters Solubility
This procedure provides a method for determining the water resistance of an adhesive by measuring its film retention part after 2 days of immersion in water.
   1. Dry a 100 mesh sieve 5 cm (W)×5 cm (L) (with 1 cm rim) in the oven at 105±5° C. for 2 hours.
   2. Weigh the sieve (W0) after having it cooled down in a desiccator for 30 minutes.
   3. Tear down the dried film and make a test piece 3 cm (W)×3 cm (L).
   4. Prepare a dry film of the emulsion on the glass plate, analog to description in “Tensile Strength & Elongation Ratio” tear it off and cut out a piece of 3 cm (W)×3 cm (L).
   5. Weigh the test piece (Ws), put it into the 250 ml Erlenmeyer flask and add 100 ml of pure water.
   6. Soak the test piece in pure water for 2 days.
   7. Filter the soaked film through the test sieve.
   8. Wash the sieve with pure water till the filtrate is clear and colorless.
   9. Dry the sieve in the oven at 105±5° C. for 3 hours.
   10. Cool the sieve in the desiccator and weigh it (W1).

Water solubility (%)=[(Ws−(W1−W0))/Ws]×100 Calculation
W0: Weight of dry and clean stainless sieve.
W1: Weight of dried stainless sieve after filtration
Ws: Weight of original untreated sample.

Particle Size

This work instruction describes the procedure to determine the particle size of VAE emulsion. Preparation of sample: Use spatula to withdraw around 0.5 g of emulsion into PE beaker, dilute and make it homogeneous with 20 ml ultra pure water. Add sample into the tank until the Mastersizer 3000 laser obscuration bar obtains 14.5-15.5%. The results will be automatically appeared after the system was cleaned. Record the average results. Report the value of Volume Weighted Mean D[4,3] and Number Weighted Mean D[1,0].

Calculate the particle size ratio:

Particle size ratio=Volume Weighted Mean (μm)/Number Weighted Mean (μm)

Method of Measurement:

SEM/EDS
Procedure
   After evaporating the residual solvent of the sample, platinum particles (current 10 mA, 300 s) were plated; and then SEM analysis (SEM analysis machine: Hitachi-SU8010 HR-FESEM) was performed.
   The acceleration voltage was set at 10 KV, the working distance of the pedestal was set at 8 mm, and the working distance set at the operation was adjusted from 8 mm.
   Current setting (condenser les) setting 5 (range 1˜16), probe current mode (normal resolution), detector selection of secondary electron detector (SE), the stage size is 2 inches.
   Set the SEM magnification to the minimum, the base working distance to 15 mm.
   Process time: X-ray (machine: HORIBA silicon draft X-ray detector (50 mm²) Depth of surface detection: 0.5 μm;
   Measurable minimum size diameter: 0.5 μm), and set the processing time: 6 (maximum time to reduce noise);
   Live time: 60 seconds to collect map time, Spectrum range: (keV);
   Spectrum display area 0˜20, Number of channels: 2K.
   In the end, silicon content of the toluene-insoluble matter was measured by SEM-EDS.

Determine Ethylene/Vinyl Acetate Ratio

Use the formula below to calculate the proportion of ethylene and vinyl acetate.

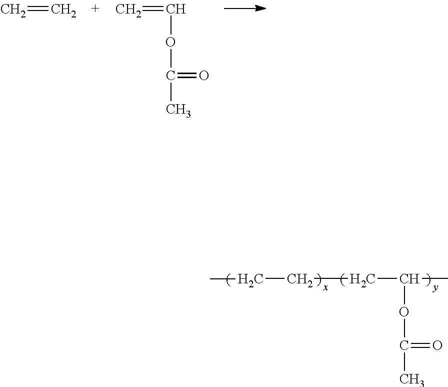

2x+4y=atomic number of carbon

2y=atomic number of oxygen Calculation:

### Comparative Example 1

Vinyl acetate ethylene copolymers-based emulsion purchased from Dairen Chemical Corporation was used as a comparative sample, and physical properties of the comparative sample were measured and presented in Table 1.

### Comparative Example 1A

Aqueous components comprising deionized water, and partially hydrolyzed polyvinyl alcohol were fed into a reactor equipped with Anchor-type impeller. The reactor was evacuated and purged with nitrogen to remove residual air. Then, reactants including ethylene gas (9.39 wt %) and vinyl acetate monomer (45.58 wt %) were fed under the agitating speed of 400 rpm, and the pressure of the reactor of 40 bars, and followed by introducing the initiator (0.12 wt. %) into the reactor to initiate the polymerization. The temperature of the reactor was raised to 70° C. and maintained for 180 mins to perform the emulsion polymerization. After completion of the polymerization, the reactor was then cooled to 65° C. The obtained emulsion was transferred to post-treatment reactor, and adding the solution containing oxidant and reducing agent in the meantime to remove residual monomers at 65° C. The silicon modified vinyl acetate ethylene copolymers-based emulsion was obtained.

### Example 1B

The same procedure of emulsion polymerization and measurement as the above Comparative Example 1A were conducted, except that the Anchor-type impeller was changed to Paddle-type impeller.

### Example 1C

The same procedure of emulsion polymerization and measurement as the above Comparative Example 1B were conducted, except that the aqueous component further comprised 0.27 of EO/PO block copolymer of formula (II), wherein X+Z in formula (II) is 40%, y in formula (II) is 6 mol; the reactants further included 0.38 wt % of vinyltrimethoxysilane (VTMO), relative to weight of the vinyl acetate monomer; and the agitating speed set at 300 rpm.

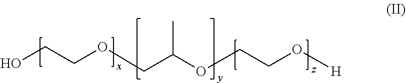

### Example 1D

The same procedure of emulsion polymerization and measurement as the above Comparative Example 1C were conducted, except that the agitating speed set at 250 rpm and the temperature of the reactor were set at 62° C.

### Example 1E

The same procedure of emulsion polymerization and measurement as the above Comparative Example 1D were conducted, except that the Paddle-type impeller was changed to Marine propeller-type impeller; and the VTMO was introduced by terminal addition, wherein the terminal addition means that 50 wt. % of vinyl acetate monomer, based on their total weight, supplied as the initial charge but not included the VTMO, and the remainder including the VTMO supplied as a feed after completion of feeding such initial charge.

### Example 1F

The same procedure of emulsion polymerization and measurement as the above Comparative Example 1E were conducted, except that the agitating speed was set at 300 rpm.

### Example 1G

The same procedure of emulsion polymerization and measurement as the above Comparative Example 1F were conducted, except that the Marine Propeller-type impeller was changed to Anchor-type impeller; the agitating speed was set at 250 rpm.

### Example 1H-1M

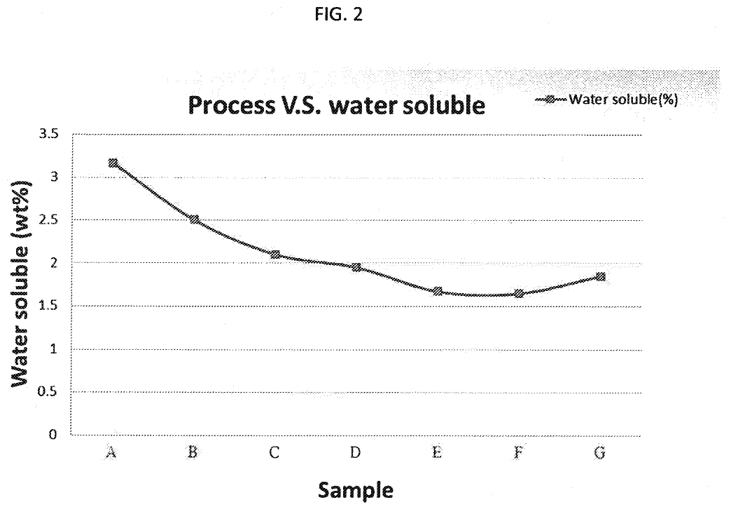

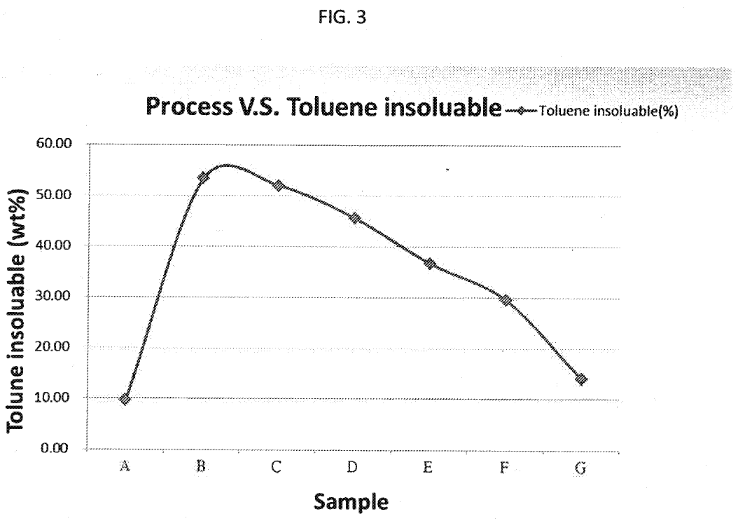

The same procedure of emulsion polymerization and measurement as the above Comparative Example 1G were conducted, except that the silicon compound and the dosage of silicon compound were changed as shown in Table 1. The visual appearance of Silicon modified vinyl acetate ethylene copolymers-based emulsion in Table 1 are milky white. The experimental conditions and the physical properties of example 1A-1M of the silicon modified vinyl acetate ethylene copolymers-based emulsion obtained were summarized in FIGS. 2-3 and FIG. 5 as Table 1. The silicon compounds listed in Table 1 are as follows: Vinyltrimethoxysilane (VTMO), vinyltriethoxysilane (VTEO), γ-methacryloxypropyltrimethoxysilane (MEMO), and vinyltris(2-methoxyethoxy)silane (VTMOEO).

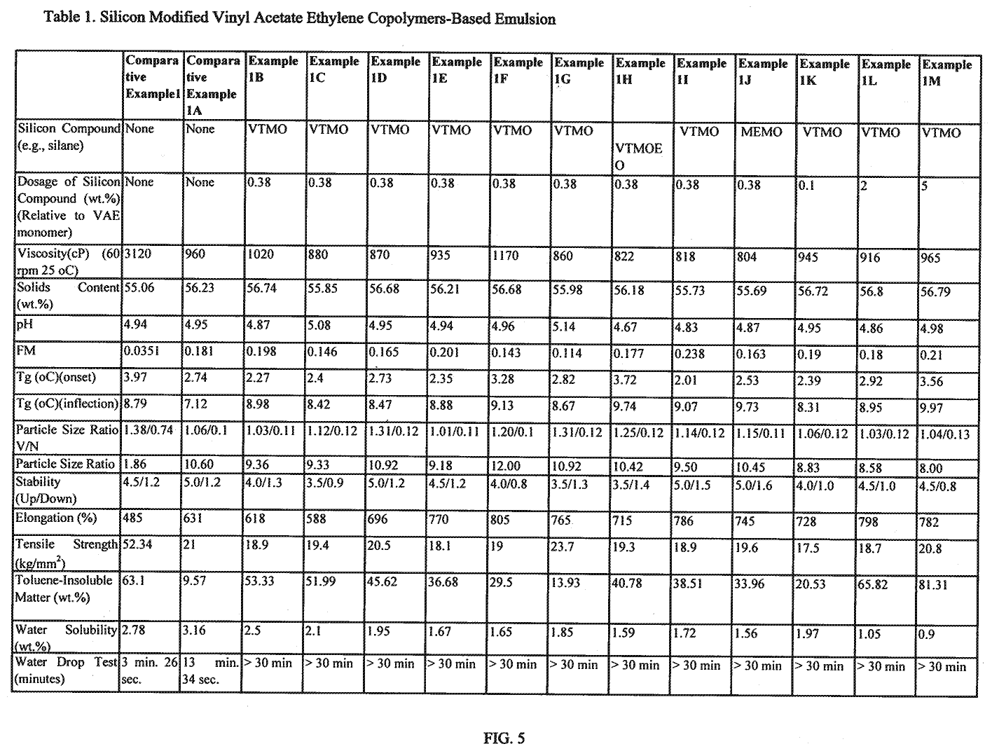

FIG. 5 illustrates Table 1 entitled Silicon Modified Vinyl Acetate Ethylene Copolymers-Based Emulsion. Comparative Examples 1 and 1A are listed together with Examples 1B, 1C, 1D, 1E, 1F, 1G, 1H, 1I, 1J, 1K, 1L and 1M.

### Examples 2A-2E

Using the analysis method of toluene-insoluble matter to obtain the insoluble part of the silicon modified vinyl acetate ethylene (VAE) copolymer from emulsion of Comparative Example 1A and Examples 1K, 1F and 1M respectively. After volatilizing the solvent, the elemental analysis of the samples was conducted by SEM/EDS and measured its silicon content and ethylene/vinyl acetate ratio in toluene-insoluble matter. The result for Comparative Example 2A and Examples 2B, 2C, and 2D were summarized in Table 2, respectively.

TABLE 2
Silicon Content and Ethylene/Vinyl Acetate Ratio in the Toluene-Insoluble Matter
of Copolymers.

| | Comparative | | | |
|---|---|---|---|---|
| | Example 2A | Example 2B | Example 2C | Example 2D |
| Emulsion Source | Comparative | Example 1K | Example 1F | Example 1M |
| | Example 1A | | | |
| Silicon Content in | N/A | 0.1 | 0.06 | 0.29 |
| Toluene-Insoluble | | | | |
| Matter (wt %) | | | | |
| Ethylene/Vinyl | N/A | 0.32:1 | 0.40:1 | 0.25:1 |
| Acetate Ratio in | | | | |
| Toluene-Insoluble | | | | |
| Matter | | | | |

N/A is “not available.”

### Comparative Example 2

The silicon modified vinyl acetate ethylene copolymer-based emulsion of Comparative Example 1 to form a liquid part. Then, a mixture of a cement containing Portland cement was prepared to form a solid part. Mixing the liquid part and the solid part in a ratio of 1:1 to obtain a cementitious waterproofing composition. The result of properties of cementitious waterproofing compositions of Comparative Examples 2 was summarized in Table 3.

### Example 3A-3M

The same procedure of emulsion polymerization and measurement as the above Comparative Example 2 were conducted, except that the emulsion source was changed as shown in Table 3. The result of properties of cementitious waterproofing compositions of Examples 3A-3M were summarized in Table 3.

Method of measurement:

Water Drop Test.
This work instruction describes the procedure to determine the water resistance of VAE emulsion.
1. Coat sample with 360 micron coating bar on glass plate. Dry the sample at room temperature for 24 hours.
2. Put the image under the glass plate. Add one drop of water on the glass plate until the image is not visible.
3. Record the time from beginning until the font disappeared.
4. The longer the time taken for the test means the better the water resistance of the sample.
5. Testing period is 30 minutes, record as 30 if the time taken is more than 30 minutes.
6. Define the level of water resistance.
   Level A: The image disappears after the water drop testing period is 60 minutes, record as level A. The more time it takes, the more waterproof they are.
   Level B: The image disappears after the water drop testing period is between 30 minutes to 60 minutes.
   Level C: The image disappears after the water drop testing period is below 30 minutes.

The meaning of open time in Table 3: When water is mixed with cement, the product sets in a few hours, and hardens over a period of time, we called that open time.

TABLE 3
Cementitious Waterproofing Compositions.

| | Comparative | | | | |
|---|---|---|---|---|---|
| | Example2 | Comparative | Example | Example | Example |
| | (Commercial) | Example 3A | 3B | 3C | 3D |
| Emulsion | | Comparative | Example | Example | Example |
| Source | | Example 1A | 1B | 1E | 1H |
| Cement | 37 | 77 | 69 | 88 | 82 |
| Amount (g) | | | | | |
| Open Time | 11 | 120 | 120 | 120 | 120 |
| 1:1 (min) | | | | | |
| Tensile Strength | 25.3 | 19.8 | 17.0 | 21.2 | 19.4 |
| (kg/mm²) | | | | | |
| Elongation (%) | 95 | 139 | 171 | 212 | 219 |
| Level | C | C | B | A | B |
| | Example 3I | Example 3J | Example 3K | Example 3L | Example 3M |
| Emulsion | Example 1I | Example 1J | Example 1K | Example 1L | Example 1M |
| Source | | | | | |
| Cement | 85 | 80 | 91 | 93 | 80 |
| Amount (g) | | | | | |
| Open Time | 120 | 120 | 120 | 120 | 120 |
| 1:1 (min) | | | | | |
| Tensile | 20.5 | 22.8 | 19.9 | 23.6 | 25.6 |
| Strength | | | | | |
| (kg/mm²) | | | | | |
| Elongation (%) | 192 | 226 | 191 | 222 | 239 |
| Level | A | A | A | A | A |

Various embodiments of this application are described herein, including the best mode known to the inventors for carrying out the application. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1.-20. (canceled)

21. A method of polymerizing a silicon modified vinyl acetate ethylene copolymer, the method comprising:
forming a copolymer comprising:
a. vinyl acetate;
b. ethylene; and
c. a silicon compound of Formula (I) 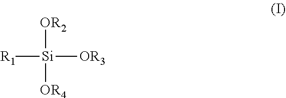
where,
R₁ is a terminally unsaturated alkenyl radical; and
R₂, R₃, and R₄ are each independently selected from the group consisting of H, alkyl, substituted alkyl, heteroalkyl, substituted heteroalkyl, cyclyl, substituted cyclyl, heterocyclyl, substituted heterocyclyl, aryl, substituted aryl, heteroaryl, and substituted heteroaryl;
comprising the steps of:
contacting an initial charge of at least 50% of the total vinyl acetate units in the polymerization method with ethylene units;
performing the contacting step in the absence of the silicon compound, and initiating polymerization of the vinyl acetate-ethylene copolymer in the absence of the silicon compound;
thereafter, feeding remaining amounts of vinyl acetate units together with the silicon compound as a feed to the initiated vinyl acetate-ethylene copolymer polymerization; and
continuing polymerization until a silicon modified vinyl acetate ethylene copolymer is formed.

22. The method of claim 21, wherein each of the step of contacting and the step of feeding are conducted in the presence of an emulsifier.

23. The method of claim 22, further comprising conducting polymerization under agitation imparted by an impeller.

24. The method of claim 21, wherein the step of continuing polymerization is conducted until a silicon modified vinyl acetate copolymer having a water solubility in the range of 0.9 to 1.85 wt. % at about 25° C. is obtained.

25. The method of claim 21, wherein the step of continuing polymerization is conducted until a silicon modified vinyl acetate copolymer having a number average molecular weight (Mn) of 24,000 to 35,000 is obtained.

26. The method of claim 21, wherein the step of continuing polymerization is conducted until a dried sample of the silicon modified vinyl acetate copolymer has an elongation at break in the range of 715 to 805%.

27. The method of claim 21, wherein the amount of silicon compound relative to the amount of vinyl acetate reactant is in the range of 0.1 to 5.0 wt. %

28. The method of claim 27, wherein the silicon compound is at least one selected from the group consisting of vinyltrimethoxysilane (VTMO), vinyltriethoxysilane (VTEO), γ-methacryloxypropyltrimethoxysilane (MEMO), and vinyltris(2-methoxyethoxy)silane (VTMOEO).

29. The method of claim 21, including the step of deriving at least one of the vinyl acetate units and ethylene units from at least one selected from the group consisting of monomers, oligomers, and precursors thereof.

30. The method of claim 21, wherein the step of continuing polymerization is conducted until a silicon modified vinyl acetate copolymer having an ethylene:vinyl acetate ratio 0.25:1˜0.40:1 is formed.

31. The method of claim 23, wherein the impeller is a Marine impeller and the silicon compound is vinyltrimethoxysilane (VTMO).

32. The method of claim 23, further comprising adjusting the impeller speed in the range of 250 to 300 revolutions per minute (rpm).

33. The method of claim 23, wherein the impeller is an Anchor-type impeller and further comprising the step of setting the impeller speed to 250 revolutions per minute (RPM).

34. The method of claim 21, further comprising, after the silicon modified vinyl acetate copolymer is formed, performing the step of adding the silicon modified vinyl acetate copolymer in aqueous form to at least one cement;
wherein a film of the aqueous silicon modified vinyl acetate, when dried, has an improved elongation; and
wherein whitening of the cement is reduced.

35. A method of polymerizing a silicon modified vinyl acetate ethylene copolymer, the method comprising:
forming a vinyl acetate-ethylene copolymer by contacting an initial charge of vinyl acetate reactant and ethylene reactant in the presence of a polymerization initiator at a temperature in the range of 60° C. to 90° C., but in the absence of any silicon compound; and thereafter,
introducing a feed of
a silicon compound selected from the group consisting of vinyltrimethoxysilane (VTMO), vinyltriethoxysilane (VTEO),
γ-methacryloxypropyltrimethoxysilane (MEMO), and vinyltris(2-methoxyethoxy)silane (VTMOEO); into the initiated vinyl acetate-ethylene copolymer polymerization;
the feed of the silicon compound occurring in the presence or absence of any additional vinyl acetate feed; and
continuing the polymerization until a silicon modified vinyl acetate-ethylene copolymer having a number average molecular weight (Mn) in the range of 24,000 to 35,000, a water solubility in the range of 0.9 to 1.85 wt. % at about 25° C., and an elongation at break in the range of 715 to 805%, is obtained.

36. The method of claim 35, wherein at least 50 wt. % of the total vinyl acetate reactant in the polymerization process is present in the initial charge.

37. The method of claim 35, wherein the silicon compound is present in an amount of 0.1 to 5 wt. %, based on the weight of the vinyl acetate and ethylene reactants.

38. The method of claim 37, wherein the vinyl acetate reactant is at least one selected from the group consisting of monomers, oligomers and precursors of vinyl acetate.

39. The method of claim 35, further comprising performing the polymerization in an emulsion, wherein the emulsion is agitated by one impeller selected from the group consisting of Marine type and Anchor-type impellers, and setting the operating speed of the one impeller in the range of 250 to 300 revolutions per minute (rpm).

40. A silicon modified vinyl acetate-ethylene copolymer produced by the process of claim 21.

41. A silicon modified vinyl acetate-ethylene copolymer produced by the process of claim 35.
